(19) United States
(12) Patent Application Publication
(10) Pub. No.: US 2026/0367637 A1
(43) Pub. Date: Nov. 19, 2026

(54) CONTROL DEVICE, CONTROL METHOD, AND PROGRAM

(71) Applicant: NEC Corporation, Tokyo (JP)

(72) Inventors: Takuya NOMURA, Tokyo (JP); Tetsuya TANABIKI, Tokyo (JP); Eiichi TOKUMI, Tokyo (JP); Takahiro MIZUTA, Tokyo (JP); Taichi SEISHI, Tokyo (JP); Kenichi KIJIMA, Tokyo (JP); Takumi KAMIYAMA, Tokyo (JP)

(73) Assignee: NEC Corporation, Tokyo (JP)

(21) Appl. No.: 19/144,053

(22) PCT Filed: Dec. 5, 2023
(86) PCT No.: PCT/JP2023/043510

§ 371 Date: Jun. 27, 2025

(30) Foreign Application Priority Data
Mar. 17, 2023 (JP) 2023-043530

(51) Int. Cl. G05D 1/622; G05D 1/24; G05D 107/13; G05D 109/20; G05D 111/10; G05D 111/30; G06T 7/70; G06V 20/17; H04W 4/40

(52) U.S. Cl. CPC G05D 1/622; G05D 1/24; G06T 7/70; G06V 20/17; H04W 4/40; G05D 2107/13; G05D 2109/20; G05D 2111/10; G05D 2111/32; G06T 2207/10032; G06T 2207/30261

(57) ABSTRACT

In this control device, a spatial information acquisition unit acquires spatial information of a movement area in which a moving body to be controlled moves. An image data acquisition unit acquires image data obtained by capturing images of the surrounding area of the moving body. An identification unit identifies the position of the moving body and a surrounding object around the moving body from the spatial information and the image data. When the surrounding object is not included in the spatial information, an instruction unit calculates the possibility of contact between the moving body and the surrounding object, and if the possibility is equal to or greater than a threshold value, outputs a signal instructing the moving body to avoid the surrounding object.

### TECHNICAL FIELD

The present disclosure relates to a control device, a control method, and a program.

### BACKGROUND ART

In social life, moving bodies using a new technology, such as drones or flight vehicles called Unmanned Air System (UAS), have become widespread.

With the spread of such moving bodies, there is a concern that the moving bodies may come into contact with each other. Therefore, a technique for avoiding such contact of the moving bodies is expected.

For example, a drone control device disclosed in PTL 1 receives state information including identification information and a current position of a drone, specifies a drone to be controlled, and transmits a control instruction to the drone specified as a drone whose state is to be changed.

In a technology disclosed in PTL 2, in a case where there is predetermined commonality in a flight airspace and a flight direction of a plurality of drones, the plurality of drones is caused to share the flight airspace on condition that formation flight for controlling mutual distances is performed.

### CITATION LIST

### Patent Literature

PTL 1: JP 2018-165931 A

PTL 2: WO 2019/054056 A1

### SUMMARY OF INVENTION

In order to avoid contact between the moving bodies, it is necessary to grasp a situation around the moving body and take an avoidance action before the contact. However, there is a possibility that the information processing capability of the moving body is not sufficient. Furthermore, for example, it is assumed that a video of the periphery of the moving body is transmitted to a server via the Internet, processing is performed on the server, and a result of the processing is transmitted to the moving body. However, there is a possibility that control cannot be made in time before collision due to network delay or the like.

In view of the above problems, an object of the present disclosure is to provide a control device or the like that suitably recognizes a situation of a moving body and suppresses a possibility of collision with an object.

A control device according to the present disclosure includes a spatial information acquisition unit, an image data acquisition unit, a specification unit, and an instruction unit. The spatial information acquisition unit acquires spatial information of a moving region in which a moving body to be controlled moves. The image data acquisition unit acquires image data obtained by capturing images of a periphery of the moving body. The specification unit specifies the position of the moving body and a surrounding object around the moving body from the spatial information and the image data. The instruction unit calculates a possibility of contact between the moving body and the surrounding object in a case where the surrounding object is not included in the spatial information, and outputs a signal giving an instruction on avoidance of the surrounding object in a case where the possibility is equal to or more than a threshold.

In a control method according to the present disclosure, a computer executes the following processing. The computer acquires spatial information of a moving region in which a moving body to be controlled moves. The computer acquires image data obtained by capturing images of the periphery of the moving body. The computer specifies the position of the moving body and a surrounding object around the moving body from the spatial information and the image data.

The computer calculates the possibility of contact between the moving body and the surrounding object in a case where the surrounding object is not included in the spatial information, and outputs a signal giving an instruction on avoidance of the surrounding object in a case where the possibility is equal to or more than the threshold.

A program according to the present disclosure causes a computer to execute the following control method. The computer acquires spatial information of a moving region in which a moving body to be controlled moves. The computer acquires image data obtained by capturing images of the periphery of the moving body. The computer specifies the position of the moving body and a surrounding object around the moving body from the spatial information and the image data. The computer calculates the possibility of contact between the moving body and the surrounding object in a case where the surrounding object is not included in the spatial information, and outputs a signal giving an instruction on avoidance of the surrounding object in a case where the possibility is equal to or more than the threshold.

According to the present disclosure, it is possible to provide a control device, a control method, and a program that suitably recognize a situation of a moving body and suppress a possibility of collision with an object.

### BRIEF DESCRIPTION OF DRAWINGS

FIG. 1 is a block diagram of a control device according to an example embodiment.

FIG. 2 is a flowchart of a control method according to the example embodiment.

FIG. 3 is a diagram illustrating a usage status of a control device according to an example embodiment.

FIG. 4 is a block diagram of the control device according to the example embodiment.

FIG. 5 is a block diagram of a moving body.

FIG. 6 is a diagram illustrating spatial information associated to a predetermined flight region.

FIG. 7 is a diagram illustrating a situation in which a moving body is moving in a predetermined flight region.

FIG. 8 is a view illustrating a three-dimensional virtual space in a case where a position of a moving body is taken as a viewpoint.

FIG. 9 is a view illustrating an image captured by an FPV camera of the moving body.

FIG. 10 is a diagram illustrating a usage status of a control device according to an example embodiment.

FIG. 11 is a block diagram of the control device according to the example embodiment.

FIG. 12 is a diagram illustrating a usage status of the control device according to the example embodiment.

FIG. 13 is a block diagram of a control device according to an example embodiment.

FIG. 14 is a flowchart of update processing performed by the control device.

FIG. 15 is a block diagram illustrating a hardware configuration of a computer.

### EXAMPLE EMBODIMENT

Hereinafter, the present invention will be described through example embodiments of the disclosure, but the disclosure according to the claims is not limited to the following example embodiments. In addition, not all the configurations described in the example embodiments are essential as means for solving the problem. For clarity of description, the following description and drawings are omitted and simplified as appropriate. In each drawing, the same elements are denoted by the same reference numerals, and redundant description is omitted as necessary.

### First Example Embodiment

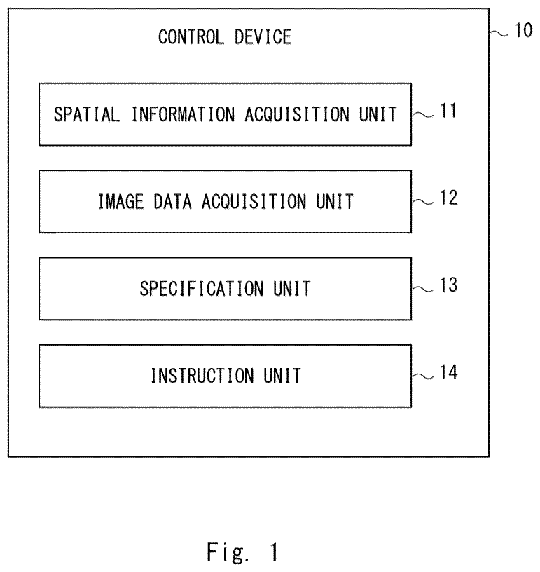

Hereinafter, the present example embodiment will be described with reference to the drawings. FIG. 1 is a block diagram of a control device 10 according to a first example embodiment. The control device 10 is a system for controlling a moving body. The moving body in the present disclosure is a flying object that moves at an altitude of several meters to several hundred meters from the ground. The moving body is, for example, an unmanned aerial vehicle called a drone or a UAS. The moving body is used for various purposes such as transportation of luggage, observation of the ground, security, and photographing. The control device 10 controls a moving body to be controlled. The control device 10 mainly includes a spatial information acquisition unit 11, an image data acquisition unit 12, a specification unit 13, and an instruction unit 14.

The spatial information acquisition unit 11 acquires, from a predetermined information source, spatial information of a moving region where a moving body to be controlled moves. The spatial information includes information regarding a moving route of the moving body in the moving region and an object around the moving route in the moving region. The spatial information is, for example, point cloud data configuring a three-dimensional space. Alternatively, the spatial information may be polygon data or wire frame data configuring a three-dimensional space. Alternatively, the spatial information may include latitude, longitude, altitude, and the like serving as indices for configuring the three-dimensional space. Furthermore, the spatial information may include attribute information of a landmark, a facility, an artifact, a natural object, or the like at a predetermined position in the three-dimensional space.

The predetermined information source is, for example, an external device communicably connected to the control device 10. In this case, the external device may be configured to be directly communicably connected to the control device 10, or may be configured to be communicably connected via a predetermined network. The predetermined information source stores the spatial information in advance and supplies the spatial information to be stored to the spatial information acquisition unit 11.

The image data acquisition unit 12 acquires image data obtained by capturing images of the periphery of the moving body. That is, the control device 10 is communicably connected to a camera that captures images of the periphery of the moving body, and acquires image data generated by capturing the images by the camera. The number of cameras may be one or more. The camera may have at least one function of panning, tilting, or zooming.

The specification unit 13 specifies a position of the moving body and a surrounding object around the moving body from the spatial information and the image data. The surrounding object is an object existing in the vicinity of a planned route of the moving body. Specifically, for example, the specification unit 13 specifies the moving body from image data obtained by capturing the images of the moving body. The specification unit 13 specifies the position of the moving body included in the image by collating the image included in the image data with the spatial information. The specification unit 13 collates the spatial information with the image data to specify a surrounding object existing around the moving body.

The instruction unit 14 determines whether the surrounding object is included in the spatial information by calculating a difference between the spatial information and the image data. When the surrounding object is not included in the spatial information, there is a possibility that the moving body and the surrounding object contact or collide with each other. Therefore, the instruction unit 14 calculates the possibility of contact between the moving body and the surrounding object when the surrounding object is not included in the spatial information. Further, the instruction unit 14 outputs a signal giving an instruction on avoidance of the surrounding object in a case where a possibility that the moving body and the surrounding object come into contact with each other is equal to or more than a threshold.

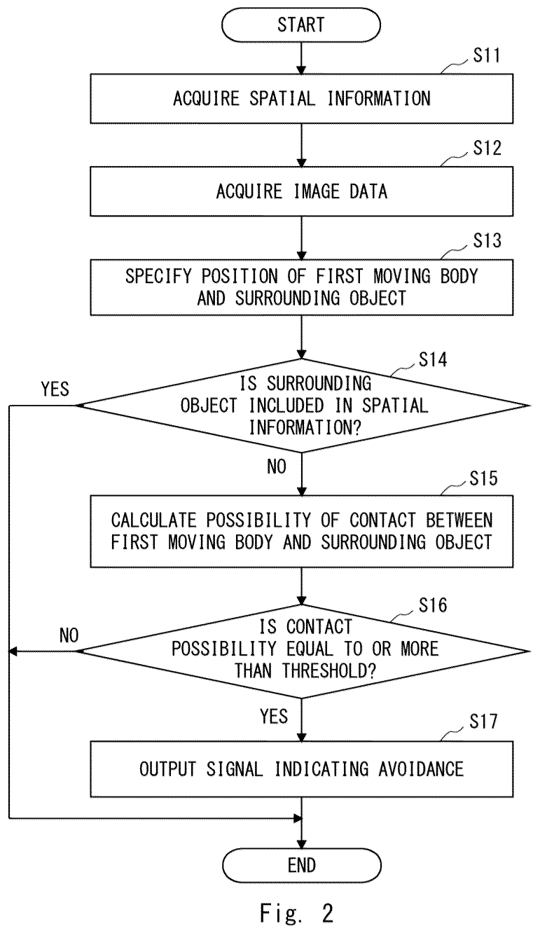

Next, processing executed by the control device 10 will be described with reference to FIG. 2. FIG. 2 is a flowchart of the control method according to the first example embodiment. The flowchart shown in FIG. 2 is executed, for example, every predetermined period after the control device 10 is activated.

First, the spatial information acquisition unit 11 acquires spatial information of a moving region in which a moving body to be controlled moves (step S11). The spatial information acquisition unit 11 supplies the acquired spatial information to the specification unit 13.

Next, the image data acquisition unit 12 acquires image data obtained by capturing images of the periphery of the moving body (step S12). The image data acquisition unit 12 supplies the acquired image data to the specification unit 13.

Next, the specification unit 13 specifies the position of the moving body and surrounding object around the moving body from the spatial information and the image data (step S13).

Next, the instruction unit 14 collates the spatial information with the image data to determine whether the surrounding object is included in the spatial information (step S14). When it is determined that the surrounding object is included in the spatial information (step S14: YES), the moving body may move according to the planned route. Therefore, in this case, the control device 10 ends the processing of this flowchart. On the other hand, when it is not determined that the surrounding object is included in the spatial information (step S14: NO), that is, when the surrounding object is not included in the spatial information, the control device 10 proceeds to step S15.

In step S15, the instruction unit 14 calculates the possibility of contact between the moving body and the surrounding object (step S15). Further, the instruction unit 14 determines whether the possibility of contact between the moving body and the surrounding object is equal to or more than a threshold (step S16). When the possibility of contact between the moving body and the surrounding object is less than the threshold, the moving body may move along the planned route. Therefore, when it is not determined that the possibility of contact between the moving body and the surrounding object is equal to or more than the threshold (step S16: NO), the control device 10 ends the processing of this flowchart.

On the other hand, in a case where the possibility that the moving body and the surrounding object come into contact with each other is equal to or more than the threshold, when the moving body moves along the planned route, there is a possibility that the moving body comes into contact with the surrounding object. Therefore, when it is determined that the possibility of contact between the moving body and the surrounding object is equal to or more than the threshold (step S16: YES), the instruction unit 14 of the control device 10 outputs a signal giving an instruction on avoidance of the surrounding object (step S17). When outputting a signal giving an instruction on avoidance of the surrounding object, the control device 10 ends a series of processing.

Through the above processing, the control device 10 suitably recognizes the situation of the moving body and suppresses the possibility of collision with the surrounding object.

The control device 10 may include a processor and a storage device as components not illustrated. The storage device included in the control device 10 includes, for example, a storage device including a nonvolatile memory such as a flash memory or a solid state drive (SSD). In this case, the storage device included in the control device 10 stores a computer program (hereinafter, also simply referred to as a program) for executing the above-described image processing method. In addition, the processor reads the computer program from the storage device into a buffer memory such as a dynamic random access memory (DRAM), and executes the program.

Each configuration of the control device 10 may be achieved by dedicated hardware. Some or all of the components may be implemented by general-purpose or dedicated circuitry, a processor, or the like, or a combination thereof. These components may be configured by a single chip, or may be configured by a plurality of chips connected to each other via a bus. Some or all of the components of each apparatus may be achieved by a combination of the above-described circuit or the like and a program. Furthermore, as the processor, a central processing unit (CPU), a graphics processing unit (GPU), a field-programmable gate array (FPGA), or the like may be used. The description regarding the configuration described here can also be applied to other apparatuses or systems described below in the present disclosure.

As described above, according to the present example embodiment, it is possible to provide the control device, the control method, and the program that suitably recognize the situation of the moving body and suppress the possibility of collision with the object.

### Second Example Embodiment

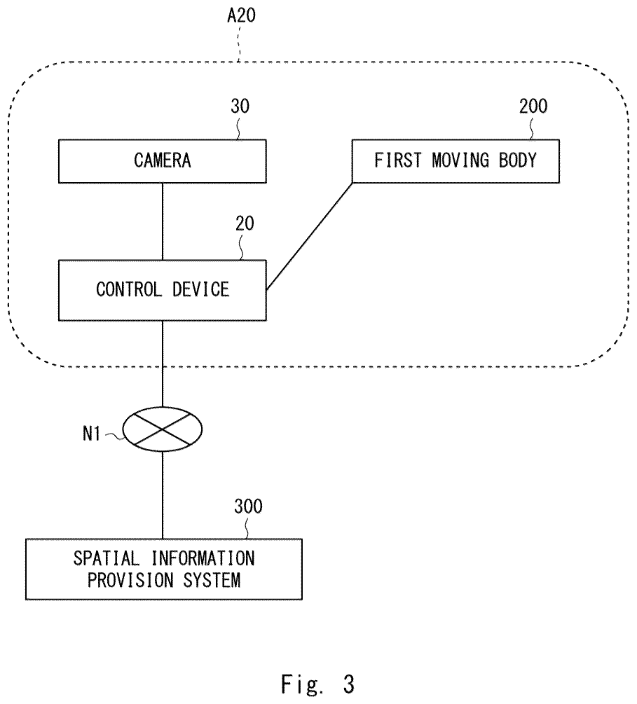

Next, a second example embodiment will be described. FIG. 3 is a diagram illustrating a usage status of a control device according to a second example embodiment. FIG. 3 includes a control device 20, a camera 30, a first moving body 200, and a spatial information provision system 300.

The control device 20 is directly communicably connected to the camera 30, and sequentially acquires image data of images captured by the camera 30. In addition, the control device 20 is wirelessly communicably connected to the first moving body 200 in a predetermined region A20, and controls the first moving body 200. Furthermore, the control device 20 is communicably connected to the spatial information provision system 300 via a network N1, and acquires the spatial information from the spatial information provision system 300.

In the above-described configuration, for example, the control device 20 controls the first moving body 200 by direct wireless communication in the predetermined region A20 that is a part of the planned route of the first moving body 200. That is, the control device 20 may be a local base station capable of high-speed communication. More specifically, for example, the control device 20 may adopt a communication technology called a local 5G network (5G (5th Generation) means a fifth-generation mobile communication system). The control device 20 may function as a multi-access edge computing (MEC) that executes predetermined information processing at a high speed in the local base station. With such a configuration, the control device 20 can suitably control the first moving body 200 which is moving.

The camera 30 is installed around the route of the first moving body 200 in the region A20, and captures images of a situation around the first moving body 200 and the first moving body 200. The camera 30 sequentially supplies image data generated from the captured images to the control device 20. The number of cameras 30 may be one or plural.

The first moving body 200 moves along the planned route in the region A20. The first moving body 200 may have a function of moving by autonomous movement, but can be controlled by the control device 20. That is, for example, while the first moving body 200 has a function of moving along the planned route, in a case where the control device 20 gives an instruction different from the original planned route, the first moving body 200 follows the instruction of the control device 20.

The spatial information provision system 300 stores spatial information of a region including the region A20, and provides the spatial information in response to a request from a consumer. That is, the spatial information provision system 300 provides the spatial information of the region A20 to the control device 20 that controls the first moving body 200 in the region A20.

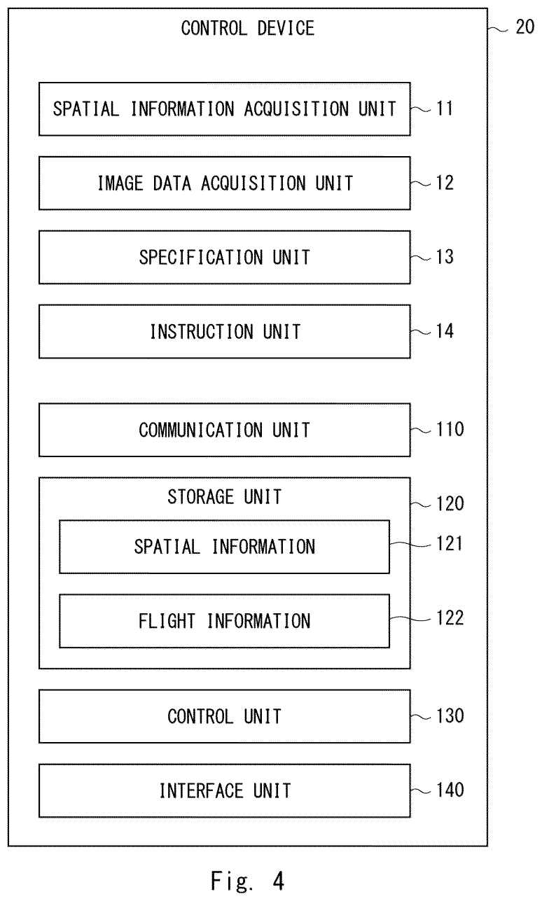

Next, the control device 20 will be further described with reference to FIG. 4. FIG. 4 is a block diagram of the control device 20 according to the second example embodiment. The control device 20 mainly includes a communication unit 110, a storage unit 120, a control unit 130, and an interface unit 140 in addition to a spatial information acquisition unit 11, an image data acquisition unit 12, a specification unit 13, and an instruction unit 14.

The spatial information acquisition unit 11 according to the present example embodiment acquires spatial information from a predetermined spatial information provision service. As a result, the control device 20 can easily receive detailed information. The spatial information acquisition unit 11 acquires spatial information including geographical information of a three-dimensional virtual space in the region A20. As a result, the control device 20 can more suitably control the first moving body 200 using both a real space and a three-dimensional virtual space.

In this case, the specification unit 13 specifies the first moving body 200 with reference to the planned route in a flight information stored in the storage unit 120. As a result, the control device 20 suitably specifies the position of the first moving body 200 in the image data. The specification unit 13 may specify the position of the moving body at the time when the image data is captured with reference to a predetermined planned route.

In the case of specifying the position of the first moving body 200, the specification unit 13 according to the present example embodiment uses image data captured by the first moving body 200 or the camera 30 installed in the region A20. Similarly, the specification unit 13 uses the image data of the image captured by the camera 30 installed in the first moving body 200 or the region A20 when specifying the surrounding object.

In a case where the possibility of contact between the first moving body 200 and the surrounding object is equal to or more than a predetermined threshold, the instruction unit 14 according to the present example embodiment outputs an instruction to secure a certain distance from the surrounding object and avoid the surrounding object. Furthermore, in a case where the surrounding object is moving, the instruction unit 14 may output an instruction to avoid the surrounding object by weighting a relative moving direction of the surrounding object.

The communication unit 110 includes an interface for performing predetermined communication and a function of modulating or demodulating a signal. The communication unit 110 performs direct wireless communication with the first moving body 200. The communication unit 110 also performs direct wireless communication with the camera 30. In this case, the communication unit 110 preferably performs local high-speed communication with the region A20 as a communicable region. The communication unit 110 also has a function of connecting to the network N1.

The control device 20 acquires an identification signal from the first moving body 200 via the communication unit 110. The identification signal is a signal transmitted by the first moving body 200 at a frequency of about once in several hundred milliseconds, for example. The identification signal includes, for example, information indicating that the moving body is moving with permission. The identification signal includes authentication data for authenticating the moving body. The identification signal includes a time when the identification signal is transmitted and position data of the moving body at the time when the identification signal is transmitted.

The specification unit 13 according to the present example embodiment can specify the position of the first moving body 200 based on the position information transmitted by the first moving body 200 and the image data. Accordingly, the control device 21 can suitably specify the position of the first moving body 200.

The storage unit 120 is a storage device including a nonvolatile memory such as a flash memory or an SSD. The storage unit 120 stores spatial information 121 and flight information 122. The storage unit 120 may store a program for the control device 20 to perform the function of the present disclosure. The spatial information 121 is spatial information including geographical information of the three-dimensional virtual space in the region A20, and is information received from the spatial information provision system 300. The flight information 122 includes at least a planned route of the first moving body 200.

The control unit 130 is a control circuit including an arithmetic device. The control unit 130 controls each component of the control device 20 in order for the control device 20 to exhibit the function of the present disclosure. The interface unit 140 includes an information input/output device for an administrator who manages the control device 20 to operate the control device 20. For example, in a case where the control device 20 controls the first moving body 200 according to the operation of the administrator, the interface unit 140 receives the operation of the administrator. More specifically, for example, the interface unit 140 may include a button for inputting information, a switch, a keyboard, a touch panel, or the like. Furthermore, the interface unit 140 may have a display for presenting predetermined information to the administrator.

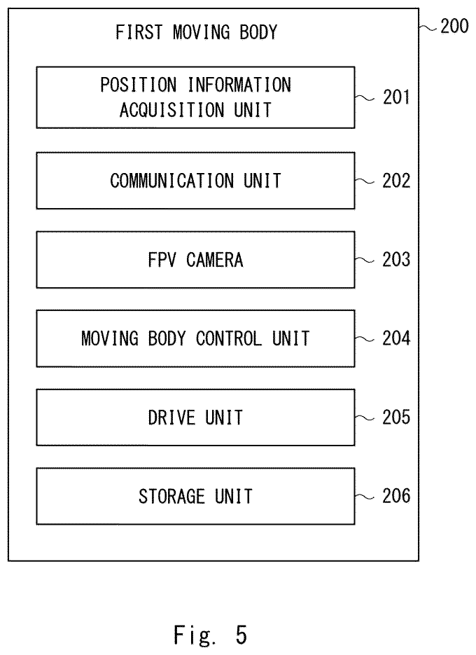

Next, the first moving body 200 will be described with reference to FIG. 5. FIG. 5 is a block diagram of the first moving body 200. The first moving body 200 is a drone that moves in the air and is an example embodiment of the moving body in the present disclosure. The first moving body 200 flies in the air along a planned flight route (planned route). The first moving body 200 mainly includes a position information acquisition unit 201, a communication unit 202, an FPV camera 203, a moving body control unit 204, a drive unit 205, and a storage unit 206.

The position information acquisition unit 201 acquires position data of the first moving body 200 using, for example, a global navigation satellite system (GNSS), a position data acquisition system using Wi-Fi radio waves, or the like. The communication unit 202 has a function for performing direct wireless communication with the control device 20. That is, the communication unit 202 may include, for example, an antenna, a modulation circuit, a demodulation circuit, and the like. The FPV camera 203 includes an objective lens, an imaging element, and the like, and captures a first person view (FPV) image of the first moving body 200.

The moving body control unit 204 includes an arithmetic device such as a CPU or an MCU, and controls each configuration of the first moving body 200. That is, for example, the moving body control unit 204 exchanges information with the control device 20 via the communication unit 202, and issues an instruction to each configuration of the first moving body 200 in response to the exchange. The drive unit 205 includes a motor for rotating a propeller which is a moving means of the first moving body 200. The storage unit 206 includes a nonvolatile memory such as a flash memory or an SSD, and stores authentication data or the like of the first moving body 200.

The first moving body 200 has the above configuration, and transmits, for example, image data of an image captured by the FPV camera 203 to the control device 20 every predetermined period. The first moving body 200 moves while periodically transmitting an identification signal stored in the storage unit 206. The first moving body 200 transmits an identification signal, for example, every several hundred milliseconds. At this time, the first moving body 200 performs this transmission by, for example, a method conforming to Bluetooth (registered trademark) or Wi-Fi standards.

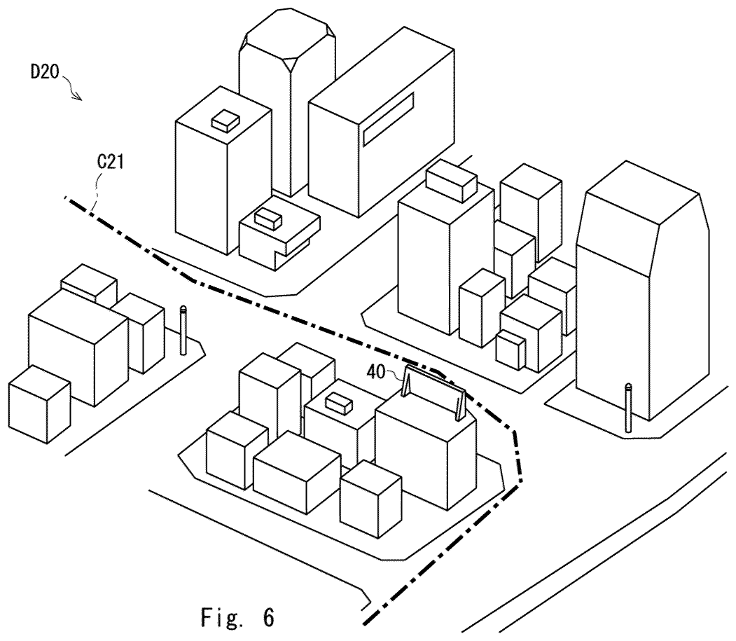

Next, the spatial information will be described with reference to FIG. 6. FIG. 6 is a diagram illustrating a virtual space D20 associated to the predetermined region A20. A virtual space D20 illustrated in FIG. 6 is a three-dimensional virtual space of an urban area where the first moving body 200 moves. The virtual space D20 includes geographical information in the region A20. The geographic information may include, for example, latitude, longitude, and altitude. Furthermore, the virtual space D20 may include attribute information of an object in the three-dimensional virtual space. The attribute information of the object in this case is, for example, information indicating a building, a road, a bridge, a river, and the like.

The virtual space D20 is set such that the planned route of the first moving body 200 can be superimposed. In FIG. 6, a virtual space D20 indicated by a thick dashed-dotted line is a first planned route C21. The first planned route C21 is a planned route of the first moving body 200. The first planned route C21 extends from an upper left to a lower right of the virtual space D20 associated to a signboard installed on a rooftop of a building in FIG. 6, and extends to a lower left while going around a right side of surrounding object data 40.

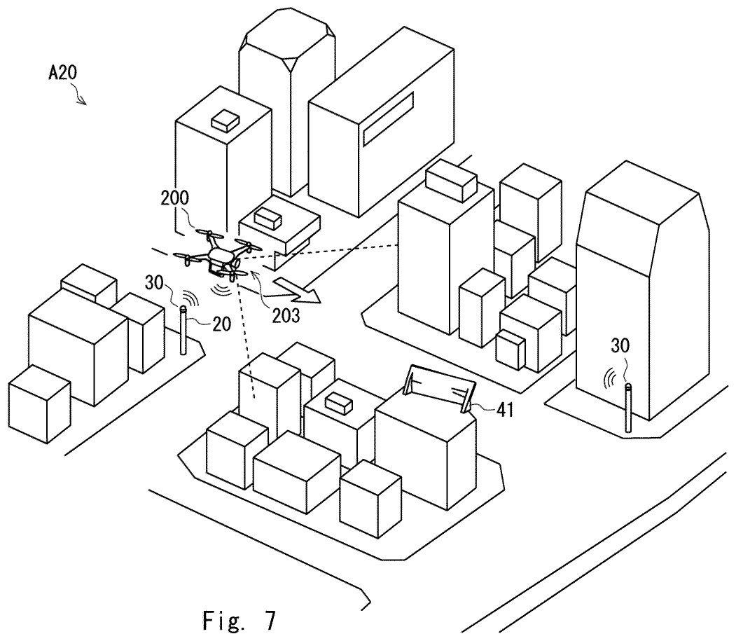

Next, a real space associated to the spatial information illustrated in FIG. 6 will be described with reference to FIG. 7. FIG. 7 illustrates a situation where the first moving body 200 is moving in an urban area which is the predetermined region A20. In FIG. 7, the first moving body 200 is moving in the region A20 along the planned route. A plurality of cameras 30 is installed in the region A20. The cameras 30 illustrated in FIG. 7 are installed at tips of poles installed on a sidewalk. The control device 20 is included in one of the poles. The cameras 30 and the control device 20 may be installed integrally with signal poles and street lamps.

A surrounding object 41 illustrated in FIG. 7 is associated to the surrounding object data 40 illustrated in FIG. 6. However, the surrounding object 41, which is a signboard of the real space illustrated in FIG. 7, is deformed for some reason, and has a form different from that of the virtual space D20. Therefore, FIG. 7 illustrates a situation in which there is a possibility that the first moving body 200 comes into contact with the surrounding object 41 if the first moving body 200 travels along the planned route as it is.

In the above-described situation, the image data acquisition unit 12 acquires a plurality of pieces of image data obtained by capturing images of the first moving body 200 and the periphery of the first moving body 200 from the cameras 30 installed at a plurality of different positions. The specification unit 13 specifies the position of the first moving body 200 and the surrounding object from the plurality of images acquired by the image data acquisition unit 12.

The control device 20 uses the information of the three-dimensional virtual space illustrated in FIG. 6 and the information of the real space illustrated in FIG. 7 for control of the first moving body 200. As a result, the control device 20 controls the first moving body 200 while suitably grasping a state of the surrounding object.

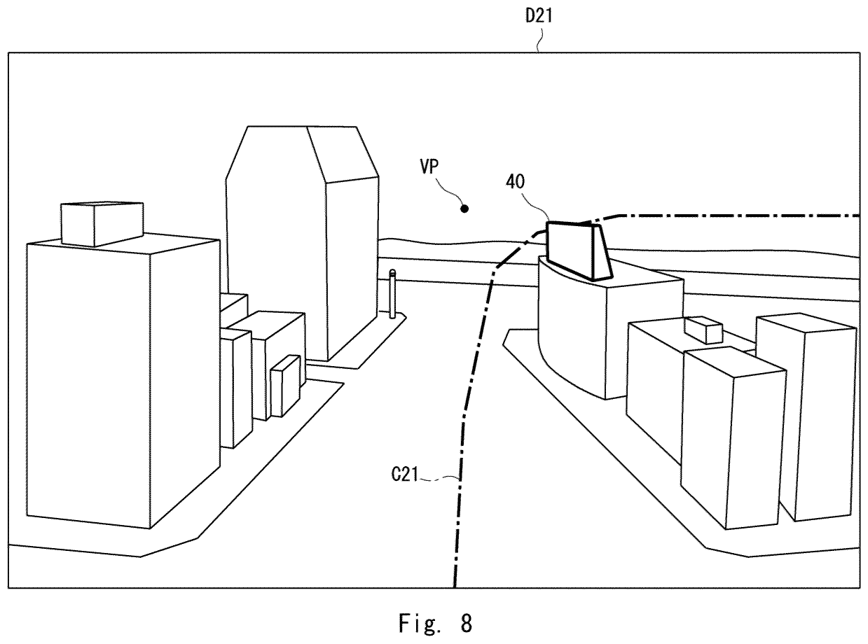

Next, an example of using images of an FPV camera included in the first moving body 200 will be described with reference to FIG. 8. FIG. 8 is a diagram illustrating a three-dimensional virtual space in a case where the position of the moving body is taken as a viewpoint. An FPV image D21 is an image of a virtual space generated from the three-dimensional virtual space illustrated in FIG. 6 with the position of the first moving body 200 illustrated in FIG. 7 as a viewpoint. In other words, the FPV image D21 illustrated in FIG. 8 is an image obtained by virtually generating the region A20 captured by the FPV camera included in the first moving body 200.

The first planned route C21 is superimposed on the FPV image D21. The first planned route C21 extends from a lower portion of the FPV image D21 toward a vanishing point VP existing in the central portion of the image, bypasses the surrounding object data 40, and is bent rightward.

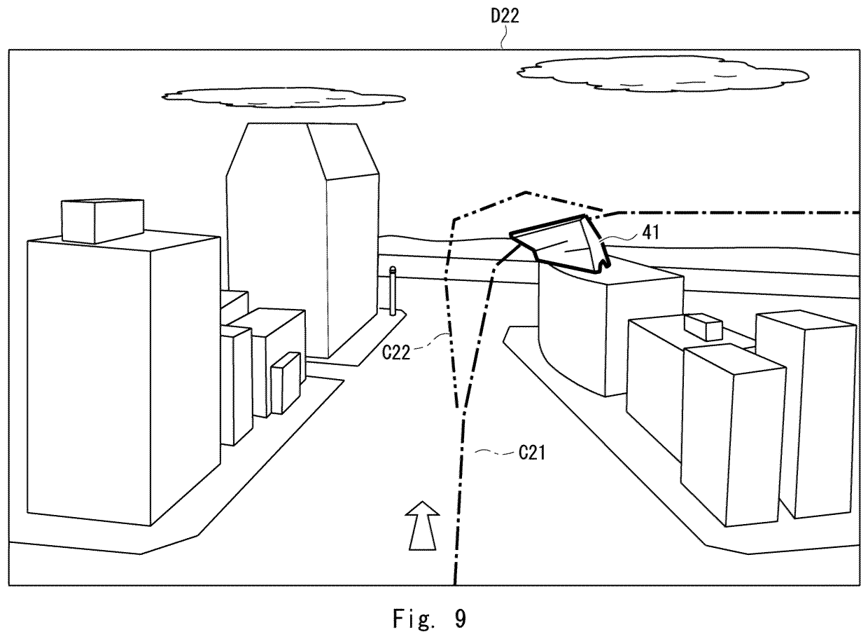

Next, an image captured by the FPV camera 203 of the first moving body 200 will be described with reference to FIG. 9. A first captured image D22 illustrated in FIG. 9 is a view illustrating an image captured by the FPV camera 203. The first planned route C21 is also superimposed on the first captured image D22. In the first captured image D22 obtained by capturing the region A20 that is a real space, the surrounding object 41 is captured. The surrounding object 41 falls down near the first planned route C21.

The control device 20 determines that the surrounding object 41 is different from the surrounding object data 40 included in the spatial information by collating the FPV image D21 illustrated in FIG. 8 with the first photographed image D22 illustrated in FIG. 9. Therefore, the instruction unit 14 of the control device 20 calculates the possibility of contact between the first moving body 200 and the surrounding object 41. In the example illustrated here, it is assumed that the instruction unit 14 calculates that the possibility of contact between the first moving body 200 and the surrounding object 41 is equal to or more than a threshold when the first moving body 200 moves on the first planned route C21 as it is. In this case, the instruction unit 14 instructs the first moving body 200 on an avoidance route C22 that can move while maintaining a certain distance from the surrounding object 41.

The second example embodiment has been described above. With the above-described configuration, the control device 20 according to the present example embodiment suitably controls the first moving body 200 using the spatial information and the image data. In the above-described example, the control device 20 is installed in the region A20, and is configured to be able to perform processing of avoiding the first moving body 200 with a relatively low delay by performing local high-speed communication. However, in a case where a concern such as a significant delay in the processing speed or interruption of communication can be resolved, the control device 20 may exist outside the region A20. That is, in this case, the control device 20 may perform communication via a predetermined wide area network (WAN) or a public telephone line instead of direct wireless communication with the first moving body 200.

In a case where the first moving body 200 can execute arithmetic processing using the spatial information and the image data, the control device 20 may be installed in the first moving body 200. Alternatively, the configuration of the control device 20 may be dispersedly arranged in these environments.

The camera 30 and the FPV camera 203 described above are not limited to the visible light camera. The camera 30 and the FPV camera 203 may include, for example, an infrared camera or a distance measuring sensor employing light detection and ranging (LiDAR). The numbers and positions of the cameras 30 and the FPV cameras 203 are not limited to those described above.

As described above, according to the present example embodiment, it is possible to provide the control device, the control method, and the program that suitably recognize the situation of the moving body and suppress the possibility of collision with the object.

### Third Example Embodiment

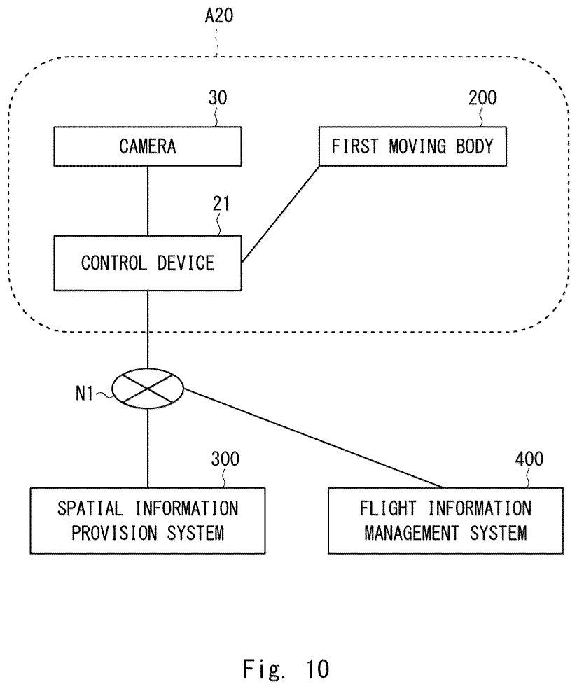

Next, a third example embodiment will be described. FIG. 10 is a diagram illustrating a usage status of the control device according to the third example embodiment. FIG. 10 includes a control device 21, a camera 30, a first moving body 200, a spatial information provision system 300, and a flight information management system 400.

The control device 21 is communicably connected to the flight information management system 400 via the network N1. The control device 21 receives flight information related to the region A20 from the flight information management system 400. That is, the control device 21 acquires, from the flight information management system 400, flight information of another moving body passing through the region A20. The control device 21 can also acquire the flight information of the first moving body 200 from the flight information management system 400. In the following description, “another moving body” is also referred to as a “second moving body”.

The flight information management system 400 is a system that manages flight plans of a plurality of moving bodies. The flight information management system 400 provides the control device 21 with the flight plans of the moving bodies in the region A20 via the network N1. As a result, the control device 21 can acquire the flight plan of the second moving body different from the first moving body 200.

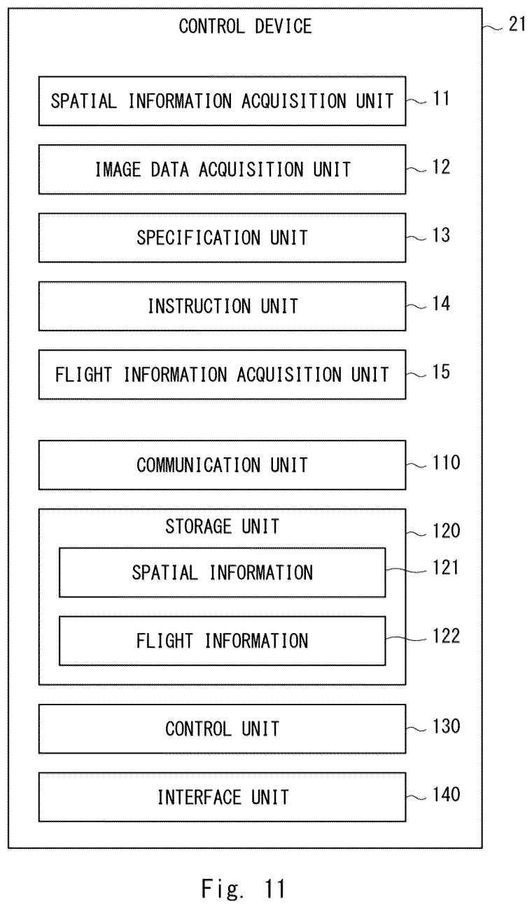

Next, the control device 21 will be described with reference to FIG. 11. FIG. 11 is a block diagram of the control device 21 according to the third example embodiment. The control device 21 according to the present example embodiment is different from the control device 20 described above in that the control device 21 includes a flight information acquisition unit 15. The control device 21 is different from the control device 20 in processing associated with acquisition of flight information.

The specification unit 13 according to the present example embodiment can specify the second moving body that is a surrounding object by collating the flight information of the second moving body acquired by the flight information acquisition unit 15 with the image data. The specification unit 13 may acquire the planned route of the moving body from the flight information of the second moving body, collate the acquired planned route with the spatial information, and specify the moving body present on the planned route as the second moving body. In the following description, the planned route of the second moving body may be referred to as a second planned route.

The specification unit 13 may specify the second moving body by collating authentication data received from the flight information management system 400 with the authentication data received from the second moving body. More specifically, the specification unit 13 acquires the authentication data of the second moving body from the flight information of the second moving body. The control device 21 receives the identification signal from the second moving body existing in the region A20 through the communication unit 110. The identification signal received via the communication unit 110 includes authentication data of the moving body. The specification unit 13 can specify the moving body included in the image data by collating them.

The instruction unit 14 according to the present example embodiment can determine that the second moving body is not included in the spatial information and calculate the possibility of contact with the second moving body. In this case, the control device 21 can estimate the movement of the second moving body from a difference between the plurality of frames of image data.

Alternatively, the instruction unit 14 can recognize the second planned route of the second moving body from the flight information of the second moving body acquired from the flight information management system 400. Therefore, the instruction unit 14 can calculate the possibility of contact between the first moving body 200 and the second moving body using the second planned route.

The specification unit 13 may specify the second moving body at the time when the image data is captured from the image data with reference to the second planned route. The specification unit 13 may specify the second moving body by collating the position of the second moving body included in the second planned route with the position of the surrounding object specified from the image data.

The flight information acquisition unit 15 acquires flight information including a second planned route of the second moving body different from the moving body from the flight information management system 400. As a result, the control device 21 can suitably specify another moving body moving along the predetermined planned route.

The control device 21 according to the present example embodiment also acquires an identification signal from the second moving body via the communication unit 110. In this case, the specification unit 13 according to the present example embodiment can receive the identification signal of the second moving body and request the flight information management system 400 for flight information associated with the identification signal of the moving body.

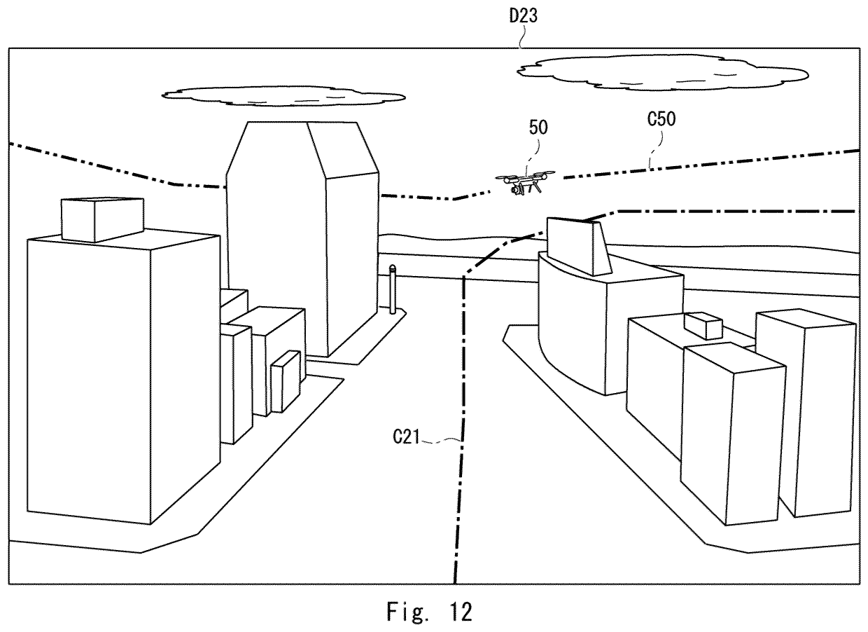

Next, a usage status of the control device 21 according to the present example embodiment will be described with reference to FIG. 12. FIG. 12 is a diagram illustrating a usage status of the control device 21 according to the third example embodiment. FIG. 12 illustrates a second captured image D23 captured by the FPV camera 203 of the first moving body 200. The second captured image D23 includes a second moving body 50. The second captured image D23 includes a first planned route C21 and a second planned route C50 superimposed on the FPV image.

In the above-described situation, for example, the specification unit 13 specifies the second moving body 50 as a peripheral object from a difference between the virtual space D20 and the second captured image D23 illustrated in FIG. 8. The specification unit 13 may specify the second moving body 50 by collating the flight information of the second moving body 50 acquired by the flight information acquisition unit 15 with the image of the second captured image D23.

The instruction unit 14 can calculate the possibility of contact with the second moving body 50 existing in a traveling direction of the first moving body 200. In this case, instruction unit 14 can estimate a moving direction and a moving speed of the second moving body 50 from a difference between the position of the second moving body 50 in the image captured immediately before the second captured image D23 and the position of the second moving body 50 in the second captured image D23. In this case, the instruction unit 14 can calculate the contact ability using the estimated moving direction and moving speed of the second moving body 50.

When the second moving body 50 is moving along the second planned route C50, the instruction unit 14 can calculate the contact possibility when the second moving body 50 moves along the second planned route C50.

The third example embodiment has been described above. According to the present example embodiment, it is possible to provide the control device, the control method, and the program that suitably recognize the situation of the plurality of moving bodies and suppress the possibility of collision with another moving body or a peripheral object.

### Fourth Example Embodiment

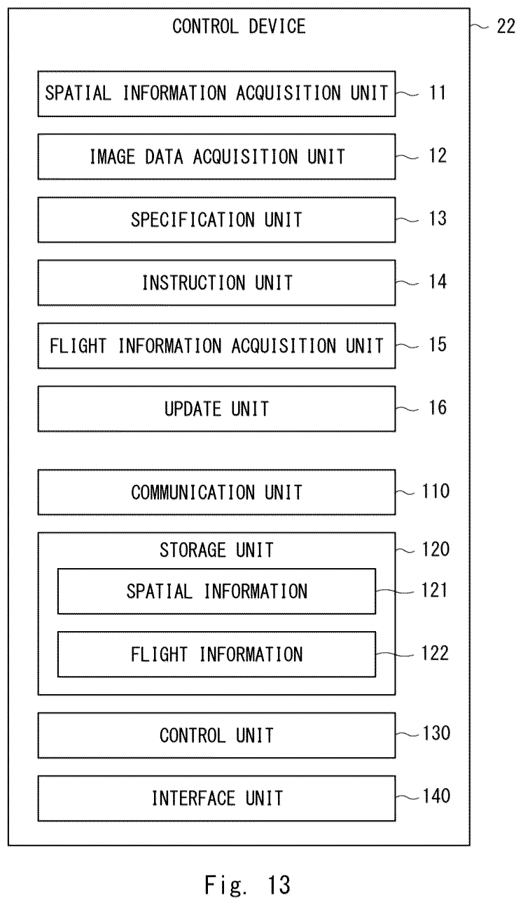

Next, a fourth example embodiment will be described. The fourth example embodiment is different from the above-described example embodiments in that the fourth example embodiment has a function of updating spatial information. FIG. 13 is a block diagram of a control device 22 according to the fourth example embodiment.

The control device 22 is different from the control device 21 according to the third example embodiment in that an update unit 16 is included. When a surrounding object not included in the spatial information satisfies a predetermined update condition, the update unit 16 updates the spatial information in order to register the surrounding object in the spatial information. The update condition is, for example, that a surrounding object not included in the spatial information is stationary for a predetermined period. In this case, the update unit 16 registers the surrounding object in the spatial information under the update condition that the surrounding object is stationary for a predetermined period.

The update condition may include a condition that a stationary surrounding object is not floating in the air but connected to the ground. Alternatively, the update condition may include a condition that the surrounding object remains within a predetermined range even if the surrounding object is not stationary. When there is a new surrounding object satisfying the above condition, the update unit 16 adds the three-dimensional data of this object to the spatial information. The update condition can be set even in a case where there is no object existing in the spatial information. With the provision of such a function, the control device 22 can flexibly reflect a situation such as extension, reconstruction, and dismantling of a building in the spatial information, for example.

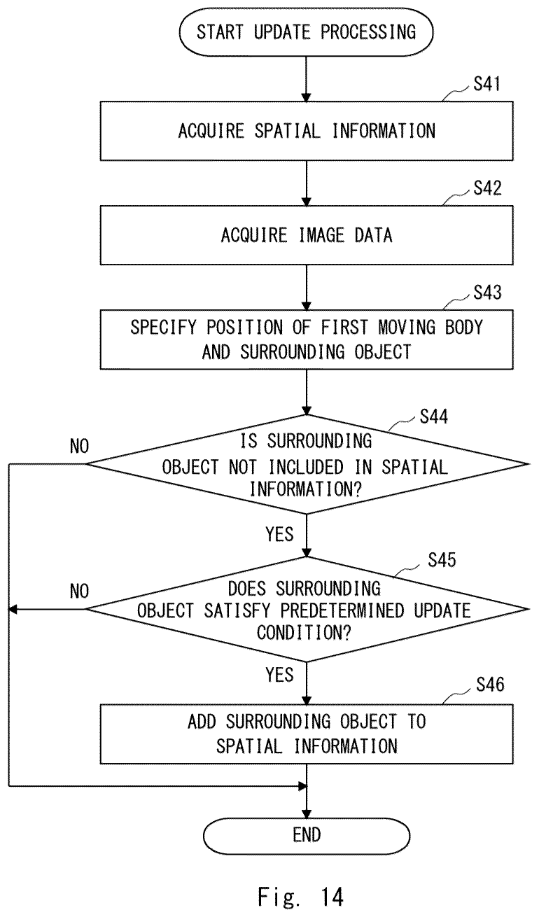

FIG. 14 is a flowchart of update processing performed by the control device 22. The flowchart of FIG. 14 starts, for example, when an administrator of the control device 22 issues an instruction to start the update processing. Alternatively, the flowchart of FIG. 14 may start at the same time as the flowchart of FIG. 2.

First, the spatial information acquisition unit 11 acquires spatial information of the region A20 (step S41). The spatial information acquisition unit 11 supplies the acquired spatial information to the specification unit 13.

Next, the image data acquisition unit 12 acquires image data obtained by capturing images of the periphery of the moving body (step S42). The image data acquisition unit 12 supplies the acquired image data to the specification unit 13.

Next, the specification unit 13 specifies the position of the moving body and a surrounding object around the moving body from the spatial information and the image data (step S43).

Next, the instruction unit 14 collates the spatial information with the image data to determine whether the surrounding object is included in the spatial information (step S44). When it is determined that the surrounding object is included in the spatial information (step S44: YES), the control device 22 ends the processing of this flowchart. On the other hand, when it is not determined that the surrounding object is included in the spatial information (step S44: NO), the control device 22 proceeds to step S45.

In step S45, the update unit 16 determines whether the surrounding object satisfies a predetermined update condition (step S45). When it is determined that the surrounding object does not satisfy the predetermined update condition (step S45: NO), the control device 22 ends the series of processing. On the other hand, when it is determined that the surrounding object satisfies the predetermined update condition (step S45: YES), the update unit 16 of the control device 22 adds the surrounding object to the spatial information as the update processing (step S46), and ends the update processing.

The fourth example embodiment has been described above. The control device 22 according to the fourth example embodiment may notify the spatial information provision system 300 that the spatial information has been updated. Alternatively, the control device 22 may supply the updated spatial information to the spatial information provision system 300. With the above configuration, according to the present example embodiment, it is possible to provide a control device, a control method, and a program that suitably recognize a surrounding object and control a moving body using information regarding the recognized surrounding object.

### Example of Hardware Configuration

Hereinafter, a case where each functional configuration of an update information generation apparatus and a static information management apparatus in the present disclosure is achieved by a combination of hardware and software will be described.

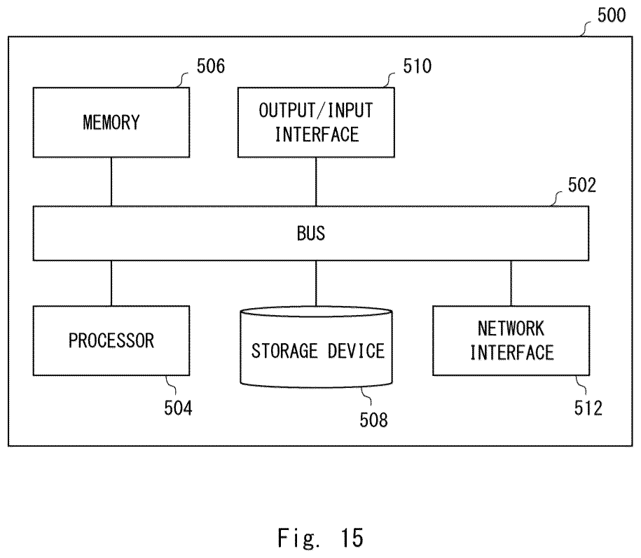

FIG. 15 is a block diagram illustrating a hardware configuration of a computer. The update information generation apparatus and the static information management apparatus in the present disclosure can achieve the above-described functions by the computer 500 including the hardware configuration illustrated in the drawing. The computer 500 may be a portable computer such as a smartphone or a tablet terminal or may be a stationary computer such as a PC. The computer 500 may be a dedicated computer designed to implement each apparatus, or may be a general-purpose computer. The computer 500 can implement a desired function by installing a predetermined application.

The computer 500 includes a bus 502, a processor 504, a memory 506, a storage device 508, an input/output interface 510, and a network interface 512. The bus 502 is a data transmission path for the processor 504, the memory 506, the storage device 508, the input/output interface 510, and the network interface 512 to transmit and receive data to and from each other. However, the method of connecting the processor 504 and the like to each other is not limited to the bus connection.

The processor 504 is various processors such as a CPU, a GPU, or an FPGA. The memory 506 is a primary storage device achieved by using a random access memory (RAM) or the like.

The storage device 508 is an auxiliary storage device achieved using a hard disk, an SSD, a memory card, a read only memory (ROM), or the like. The storage device 508 stores a program for achieving a desired function. The processor 504 reads the program to the memory 506 and executes the program to achieve each functional component of each apparatus.

The input/output interface 510 is an interface connecting the computer 500 and an input/output device. For example, an input device such as a keyboard and an output device such as a display device are connected to the input/output interface 510.

The network interface 512 is an interface connecting the computer 500 to a network.

Although the present invention has been described above with reference to the example embodiments, the present invention is not limited to the above. Various modifications that can be understood by those skilled in the art can be made to the configuration and details of the present invention within the scope of the invention.

Some or all of the above example embodiments may be described as the following supplementary notes, but are not limited to the following.

### (Supplementary Note 1)

A control device including:
a spatial information acquisition unit for acquiring spatial information of a moving region in which a moving body to be controlled moves;
an image data acquisition unit for acquiring image data obtained by capturing an image of a periphery of the moving body;
a specification unit for specifying a position of the moving body and a surrounding object around the moving body from the spatial information and the image data; and
an instruction unit for calculating a possibility of contact between the moving body and the surrounding object in a case where the surrounding object is not included in the spatial information, and output a signal giving an instruction on avoidance of the surrounding object in a case where the possibility is equal to or more than a threshold.

### (Supplementary Note 2)

The control device according to Supplementary Note 1, in which
the spatial information acquisition unit acquires the spatial information on which a first planned route of the moving body can be superimposed, and
the specification unit specifies the moving body with reference to a predetermined first planned route.

### (Supplementary Note 3)

The control device according to Supplementary Note 2, further including
a flight information acquisition unit for acquiring flight information including a second planned route of a second moving body different from the moving body,
in which the specification unit specifies the second moving body at a time when the image data is captured from the image data, with reference to the second planned route.

### (Supplementary Note 4)

The control device according to Supplementary Note 3, in which
the specification unit specifies the second moving body by collating a position of the second moving body included in the second planned route with the specified position of the surrounding object.

### (Supplementary Note 5)

The control device according to Supplementary Note 1, in which
the specification unit specifies the position of the surrounding object based on a plurality of pieces of the image data obtained by capturing images of the periphery of the moving body from a plurality of different positions.

### (Supplementary Note 6)

The control device according to Supplementary Note 1, further including
a communication unit for performing direct wireless communication with the moving body,
in which the specification unit specifies the position of the moving body based on position information transmitted by the moving body and the image data.

### (Supplementary Note 7)

The control device according to Supplementary Note 1, in which
the spatial information acquisition unit acquires the spatial information from a predetermined spatial information provision service.

### (Supplementary Note 8)

The control device according to any one of Supplementary Notes 1 to 7, in which
the spatial information acquisition unit acquires the spatial information including geographical information of a three-dimensional virtual space in the moving region.

### (Supplementary Note 9)

The control device according to Supplementary Note 8, further including
an update unit for updating the spatial information to register the surrounding object in the spatial information when the surrounding object not included in the spatial information satisfies a predetermined update condition.

### (Supplementary Note 10)

The control device according to Supplementary Note 9, in which
the update unit registers the surrounding object in the spatial information with a condition that the surrounding object is stationary for a predetermined period as the update condition.

### (Supplementary Note 11)

A control method including:
by a computer,
acquiring spatial information of a moving region in which a moving body to be controlled moves;
acquiring image data obtained by capturing an image of a periphery of the moving body;
specifying a position of the moving body and a surrounding object around the moving body from the spatial information and the image data; and
calculating a possibility of contact between the moving body and the surrounding object in a case where the surrounding object is not included in the spatial information, and outputting a signal giving an instruction on avoidance of the surrounding object in a case where the possibility is equal to or more than a threshold.

### (Supplementary Note 12)

A program for causing a computer to execute a control method including:
acquiring spatial information of a moving region in which a moving body to be controlled moves;
acquiring image data obtained by capturing an image of a periphery of the moving body;
specifying a position of the moving body and a surrounding object around the moving body from the spatial information and the image data; and
calculating a possibility of contact between the moving body and the surrounding object in a case where the surrounding object is not included in the spatial information, and outputting a signal giving an instruction on avoidance of the surrounding object in a case where the possibility is equal to or more than a threshold.

Some or all of the elements (for example, configurations and functions) described in Supplementary Notes 2 to 10 dependent on Supplementary Note 1 can also depend on Supplementary Notes 11 and 12 in the same dependency relationship as Supplementary Notes 2 to 10. Some or all of the elements described in any Supplementary Note may be applied to various types of hardware, software, recording means for recording software, systems, and methods.

This application is based upon and claims the benefit of priority from Japanese patent application No. 2023-043530, filed on Mar. 17, 2023, the disclosure of which is incorporated herein in its entirety by reference.

### INDUSTRIAL APPLICABILITY

The present disclosure is applicable to, for example, a control device and a control system that control flight of a moving body in a predetermined region.

### REFERENCE SIGNS LIST

10 control device
11 spatial information acquisition unit
12 image data acquisition unit
13 specification unit
14 instruction unit
15 flight information acquisition unit
16 update unit
20 control device
21 control device
22 control device
30 camera
40 surrounding object data
41 surrounding object
50 second moving body
110 communication unit
120 storage unit
121 spatial information
122 flight information
123 identification signal information
130 control unit
140 interface unit
200 first moving body
201 position information acquisition unit
202 communication unit
203 FPV camera
204 moving body control unit
205 drive unit
206 storage unit
300 spatial information provision system
400 flight information management system
500 computer
502 bus
506 memory
508 storage device
510 input/output interface
512 network interface
A20 region
N1 network
C21 first planned route
C22 avoidance route
C50 second planned route
D20 virtual space
D21 FPV image
D22 first captured image
D23 second captured image

What is claimed is:

1. A control device comprising:
a memory storing instructions; and
a processor configured to execute the instructions to:
acquire spatial information of a moving region in which a moving body to be controlled moves;
acquire image data obtained by capturing an image of a periphery of the moving body;
specify a position of the moving body and a surrounding object around the moving body from the spatial information and the image data; and
calculate a possibility of contact between the moving body and the surrounding object in a case where the surrounding object is not included in the spatial information, and output a signal giving an instruction on avoidance of the surrounding object in a case where the possibility is equal to or more than a threshold.

2. The control device according to claim 1, wherein
the processor configured to execute the instructions to acquire the spatial information on which a first planned route of the moving body can be superimposed, and
specify the moving body with reference to a predetermined first planned route.

3. The control device according to claim 2, further the processor configured to execute the instructions to
information acquire flight information including a second planned route of a second moving body different from the moving body, and
specify the second moving body at a time when the image data is captured from the image data, with reference to the second planned route.

4. The control device according to claim 3, wherein
the processor configured to execute the instructions to specify the second moving body by collating a position of the second moving body included in the second planned route with the specified position of the surrounding object.

5. The control device according to claim 1, wherein
the processor configured to execute the instructions to specify the position of the surrounding object based on a plurality of pieces of the image data obtained by capturing images of the periphery of the moving body from a plurality of different positions.

6. The control device according to claim 1, further the processor configured to execute the instructions to
perform direct wireless communication with the moving body, and
specify the position of the moving body based on position information transmitted by the moving body and the image data.

7. The control device according to claim 1, wherein
the processor configured to execute the instructions to acquire the spatial information from a predetermined spatial information provision service.

8. The control device according to claim 1, wherein
the processor configured to execute the instructions to acquire the spatial information including geographical information of a three-dimensional virtual space in the moving region.

9. The control device according to claim 8, further the processor configured to execute the instructions to
update the spatial information to register the surrounding object in the spatial information when the surrounding object not included in the spatial information satisfies a predetermined update condition.

10. The control device according to claim 9, wherein
the processor configured to execute the instructions to register the surrounding object in the spatial information with a condition that the surrounding object is stationary for a predetermined period as the update condition.

11. A control method comprising:
by a computer,
acquiring spatial information of a moving region in which a moving body to be controlled moves;
acquiring image data obtained by capturing an image of a periphery of the moving body;
specifying a position of the moving body and a surrounding object around the moving body from the spatial information and the image data; and
calculating a possibility of contact between the moving body and the surrounding object in a case where the surrounding object is not included in the spatial information, and outputting a signal giving an instruction on avoidance of the surrounding object in a case where the possibility is equal to or more than a threshold.

12. The control method according to claim 11, wherein
the processing of acquiring the spatial information further comprises acquiring the spatial information on which a first planned route of the moving body can be superimposed, and
the processing of specifying the surrounding object further comprises specifying the moving body with reference to a predetermined first planned route.

13. The control method according to claim 12, further comprising
acquiring flight information including a second planned route of a second moving body different from the moving body,
wherein the processing of specifying the surrounding object further comprises specifying the second moving body at a time when the image data is captured from the image data with reference to the second planned route.

14. The control method according to claim 13, wherein
the processing of specifying the surrounding object further comprises specifying the second moving body by collating the position of the second moving body included in the second planned route with the specified position of the surrounding object.

15. The control method according to claim 11, wherein
the processing of specifying the surrounding object further comprises specifying the position of the surrounding object based on a plurality of pieces of the image data obtained by capturing images of the periphery of the moving body from a plurality of different positions.

16. The control method according to claim 11, further comprising
performing direct wireless communication with the moving body,
wherein the processing of specifying the surrounding object further comprises specifying the position of the moving body based on position information transmitted by the moving body and the image data.

17. The control method according to claim 11, wherein
the processing of acquiring the spatial information further comprises acquiring the spatial information from a predetermined spatial information provision service.

18. The control method according to claim 11, wherein
the processing of acquiring the spatial information further comprises acquiring the spatial information including geographic information of a three-dimensional virtual space in the moving region.

19. The control method according to claim 18, further comprising
updating the spatial information to register the surrounding object in the spatial information when the surrounding object not included in the spatial information satisfies a predetermined update condition.

20. A non-transitory computer readable medium storing a program for causing a computer to execute a control method comprising:
acquiring spatial information of a moving region in which a moving body to be controlled moves;
acquiring image data obtained by capturing an image of a periphery of the moving body;
specifying a position of the moving body and a surrounding object around the moving body from the spatial information and the image data; and
calculating a possibility of contact between the moving body and the surrounding object in a case where the surrounding object is not included in the spatial information, and outputting a signal giving an instruction on avoidance of the surrounding object in a case where the possibility is equal to or more than a threshold.
